(19) United States
(12) Patent Application Publication
(10) Pub. No.: US 2005/0213933 A1
(43) Pub. Date: Sep. 29, 2005

(54) Electronic equipment combination provided with a recording/playback device

(75) Inventors: Koichi Tajima, Takefu-city (JP); Yasuhiro Miyagoshi, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/085,195

(22) Filed: Mar. 22, 2005

(30) Foreign Application Priority Data
Mar. 26, 2004 (JP) 2004-091922

(51) Int. Cl. H04N 5/781

(52) U.S. Cl. 386/46; 386/125

(57) ABSTRACT

To provide an electronic equipment combination which can intensify the mounting area of high-back electronic components by designing an arrangement of main board to achieve effective use, reduce the sizes of main board and assure space to enable attaching an additional recording/playback device such as an HDD or the like in a television receiver built-in with a recording/playback device such as a DVD or the like.

An electronic equipment combination which enables intensifying high-back electronic components 18 dispersed and arranged to enclose the periphery of a recording/playback device 14 into a : shape to improve the mounting density and enable to attach additional recording/reproduction device such as an HDD or the like in a case by arranging a carry-in/carry-out part 13 of tray for replacing the recording medium so that it becomes the center in front of equipment on the display side and offset arranging a main board 15 from the center A of equipment to one end side.

The present application is based on and claims priority of Japanese patent application No. 2004-091922 filed on Mar. 26, 2004, the entire contents of which are hereby incorporated by reference.

### BACKGROUND OF THE INVENTION

1. Field of the Invention

The present invention relates to an electronic equipment combination provided with a recording/playback device, and relates in particular to an electronic equipment combination provided with a recording/playback device such as a DVD or the like.

2. Description of the Related Art

In a television receiver provided with a Braun tube and a built-in recording/playback device such as a DVD or the like, as in FIG. 5, a main electronic circuit board 15 for processing a power circuit of equipment or an analog signal such as an image output, etc. is arranged at nearly the central of the case bottom of a television receiver body, and a recording/playback device 14 such as a DVD or the like which has a built-in digital signal processing circuit board and which is electromagnetically shielded by a metal case at nearly the central of the case bottom is arranged on the main electronic circuit board, constructing the power circuit and the analog signal circuit as before. Thus, the recording/playback device such as a DVD or the like is arranged on the main electronic circuit board and a cathode ray tube 11 is arranged immediately above it, therefore the recording/playback device disturbs and decreases the effective area usable for arranging large-size electronic components on the main electronic circuit board. Moreover, it has been known that the temperature inside the case is made to be a fairly high temperature by heat generating from the recording/playback device and cathode ray tube of the television receiver, and for example, it reaches the high temperature of about 90° C. to 100° C. in a DVD.

The circuit board of the television receivers provided with a Braun tube comprises two (main and subsidiary) electronic circuit boards, which generally construct a main electronic circuit board 15 by cutting out a portion from one board to reduce the cost and by processing a power circuit and an analog signal such as image output, etc. and a small subsidiary electronic circuit board (not illustrated as a conventional example) for outputting a signal to a cathode ray tube. An effort has been made to arrange the small subsidiary electronic circuit board outputting a signal to the cathode ray tube on this site so that the position 15a (expressed by a chain line) where a small subsidiary electronic circuit board which outputs a signal to the cathode ray tube is cut out and can be utilized to avoid a support/fixing part 17a provided by molding a part of chassis 17 to support/fix a recording/playback device such as a DVD or the like.

The main electronic circuit board 15 of the television receiver is preliminarily mounted on the chassis 17 arranged under it, the chassis 17 being supported/fixed in the support structure of the floor in the case of the television receiver body with screw. Successively, the recording/playback device such as a DVD or the like is frequently supported/fixed with screw, etc. by a support/fixing part 17a of the recording/playback device such as a DVD or the like provided on the chassis 17, their installation in a narrow space on the inner side of case of receiver body becoming a primary factor in the reduction of operating efficiency.

Prior art relating to a television receiver built-in with such a recording/playback device is disclosed in the Japanese Laid-Open Patent Application H8-56318 (Patent Document 1).

From these constructions, there exists only an area which overlaps with the recording/reproduction device 14 such as a DVD or the like in nearly the central part of the main electronic circuit board 15 for processing the power circuit or analog signal such as image output, etc. of the television receiver, a narrow gap being formed with the electronic circuit board in the high direction. Moreover, a small subsidiary electronic circuit board for outputting a signal to the cathode ray tube by means of a part of one main electronic circuit board is generally constructed and a cutout hole 15a exists on this kind of electronic circuit board with the purpose of reducing costs. Hence electronic components cannot be mounted in this location. Accordingly, the area overlapping with the recording/playback device such as a DVD or the like only has a gap of around 1 cm, in which electronic and high-back electronic components cannot be arranged, and in which only electronic components limited to a low-back of about 0.7 cm or less, such as IC or transverse mounting type small resistors, low-capacity electrolytic condensers, etc. (not illustrated) can be arranged. Therefore, the main electronic circuit board of the television receiver body cannot be miniaturized because of limits to arranging high-back electronic components 18, such as power source transformer or choke coil constructing the power circuit in the remaining area, power transistor or thyristor mounted with radiating fins and cement resistors as well as flyback transformer or tuner, and the like constructing the signal circuit. Furthermore, there is an unreasonable connection line arrangement of electronic components because the high-back electronic components 18 are arranged in a :-shaped narrow and long area so as to enclose the periphery of a recording/reproduction device such as a DVD or the like.

Therefore, as a method for increasing the mounting density of the main electronic circuit board to reduce the surface area of the board, relays or electrolytic condensers with slightly large capacity, and the like which are relatively low-back electronic components sometimes are also mounted in the area 15b overlapping with a recording/playback device such as a DVD or the like, but the gap height from the main electronic circuit board to the recording/playback device such as a DVD or the like increases. Consequently, there has been the drawback that the total height of the television receiver body increases. Moreover, a sufficient space capable of attaching additional recording/playback device such as HDD or the like inside the case of main body of a television receiver has also been difficult to assure. Furthermore, there has been the problem that electronic components for generating a higher temperature, e.g., radiating fins of a power transistor, cement resistor, or the like are arranged to enclose the periphery of a recording/playback device such as a DVD or the like. Therefore the recording/playback device such as a DVD or the like is further heated.

The main electronic circuit board 15 of the television receiver is supported/fixed on the floor in the case of receiver main body with screw in a state of pre-mounting it to the chassis 17. Successively, the recording/playback device such as a DVD or the like is directly supported/fixed to the support/fixing part 17b of the recording/playback device provided on the chassis in many cases, and their installation in a narrow space on the inner side of case of receiver main body has been a primary factor in reducing operating efficiency.

### SUMMARY OF THE INVENTION

The present invention was made in view of above problems and is characterized by an electronic equipment combination provided with a recording/playback device wherein the recording/reproduction device is arranged so that the carry-in/carry-out position of a tray for replacing the recording medium becomes centered in the cross-wise direction in front of the electronic equipment combination, and the recording/playback device and an electronic circuit board relating to a power circuit or image signal processing, etc. of the television receiver are offset from the center of the electronic equipment combination in the cross-wise direction in an electronic equipment combination provided with a recording/playback device capable of inserting and discharging a recording medium and a television receiver provided with a Braun tube.

It is an objective of the present invention to provide an electronic equipment combination capable of decreasing the size in making effective use of a space of board. Moreover, the present invention provides an electronic equipment combination raising the installation operating efficiency of a recording/playback device such as a DVD or the like and the main electronic circuit board. Furthermore, the present invention provides an electronic equipment combination which has excellent radiating properties. Furthermore, the present invention provides a precedent electronic equipment combination in which electronic equipment provided with other recording/playback devices such as an HDD or the like is mounted in the future to an end space located opposite to the main electronic circuit board, guaranteed by the offset arrangement of the main electronic circuit board from the central of equipment the other end side in the cross-wise direction.

The electronic equipment combination having the recording/playback device of claim 1 of the present invention is characterized by having an electronic equipment combination provided with a recording/playback device arranged so that the carry-in/carry-out position of a tray for replacing the recording medium becomes centered in the cross-wise direction in front of the electronic equipment combination, and the recording/playback device and an electronic circuit board relating to a power circuit or image signal processing, and the like of the television receiver are offset from the center of the electronic equipment combination in the cross-wise direction in an electronic equipment combination provided with a recording/playback device capable of inserting and discharging a recording medium and a television receiver provided with a Braun tube.

The electronic equipment combination having the recording/playback device of claim 2 of the present invention is characterized by an electronic equipment combination provided with a recording/playback device arranged so that the carry-in/carry-out position of a tray for replacing the recording medium becomes centered in the cross-wise direction in front of the electronic equipment combination, the recording/playback device and an electronic circuit board relating to a power circuit or image signal processing, and the like of the television receiver being offset from the center of the electronic equipment combination in the cross-wise direction, a space being formed on the side opposite to the offset of the electronic circuit board in an electronic equipment combination provided with a recording/playback device capable of inserting and discharging a recording medium and a television receiver provided with a Braun tube.

The electronic equipment combination having the recording/playback device of claim 3 of the present invention is characterized by the fact that the recording/playback device is a recording/playback device capable of inserting and discharging a recording medium such as a DVD or the like.

The electronic equipment combination having the recording/playback device of claim 4 of the present invention is characterized by the fact that the recording/playback device is a recording/playback device capable of inserting and discharging a recording medium such as a DVD or the like and the space formed on the side opposite to the offset of the electronic circuit board is a precedent space for arranging an HDD.

According to the construction of claim 1 of the present invention, space for arranging large-size electronic components on the main circuit board can be assured and the space of board inside the case of a combination type television receiver is effectively used to decrease the size without causing a reduction of operability, for example, the exchange of recording medium of the recording/playback device such as a DVD or the like can be performed on the same surface as the image display surface of the television receiver, because the main electronic circuit board inside the case is offset as shown in FIG. 1.

For example, using the main electronic circuit board of same surface area as a conventional example, the degree of freedom of arrangement of high-back electronic components mounted on the main electronic circuit board is sharply improved because the surface area of an overlapping part which becomes the lower part of the recording/playback device such as a DVD or the like can be decreased and a previous narrow and long mounting area dispersed/arranged on both sides of DVD before can be widely collected into an L shape, enabling relaxation of unreasonable wiring among the electronic components and reducing the surface area of board by improving the mounting density of electronic circuit boards.

This also enables mounting radiation fins of power transistors and thyristors, cement resistors, and the like for generating a higher temperature in the L-shape wide area, enabling the improvement of the radiation from these electronic component, and relieving the influence on a DVD device generating heat at high temperatures. The need to mount a relatively high-back choke coil or electrolytic condenser under the DVD device can also be eliminated.

Moreover, the cooling efficiency of heat generating from cathode ray tube, electronic components constructing power circuit, recording/playback device such as a DVD or the like can be raised. Furthermore, an operation for mounting them to the case can be facilitated by mounting the recording/playback device and the electronic circuit board to the chassis, forming a unit, and then mounting the unit to the equipment case.

According to the construction of claim 2, space on one end side located opposite the main electronic circuit board is assured by offsetting the main electronic circuit board in the case from the central part of equipment to the other end side in the cross-wise direction, and electronic equipment provided with another recording/playback device such as an HDD or the like can be mounted in the future.

### BRIEF DESCRIPTION OF THE DRAWINGS

FIG. 1 is an explanatory diagram showing an arrangement in a DVD built-in television receiver showing an embodiment of the present invention;

FIG. 2 is an explanatory diagram showing the relative positions of main board and DVD showing an embodiment of the present invention;

FIG. 3 is an explanatory diagram showing the state of lateral sectional view of a DVD built-in television receiver showing an embodiment of the present invention;

FIG. 4 is an explanatory diagram of a DVD built-in television receiver showing an embodiment of the present invention; and

FIG. 5 is an explanatory diagram showing an arrangement in a conventional DVD built-in television receiver.

### DETAILED DESCRIPTION OF THE PREFERRED EMBODIMENTS

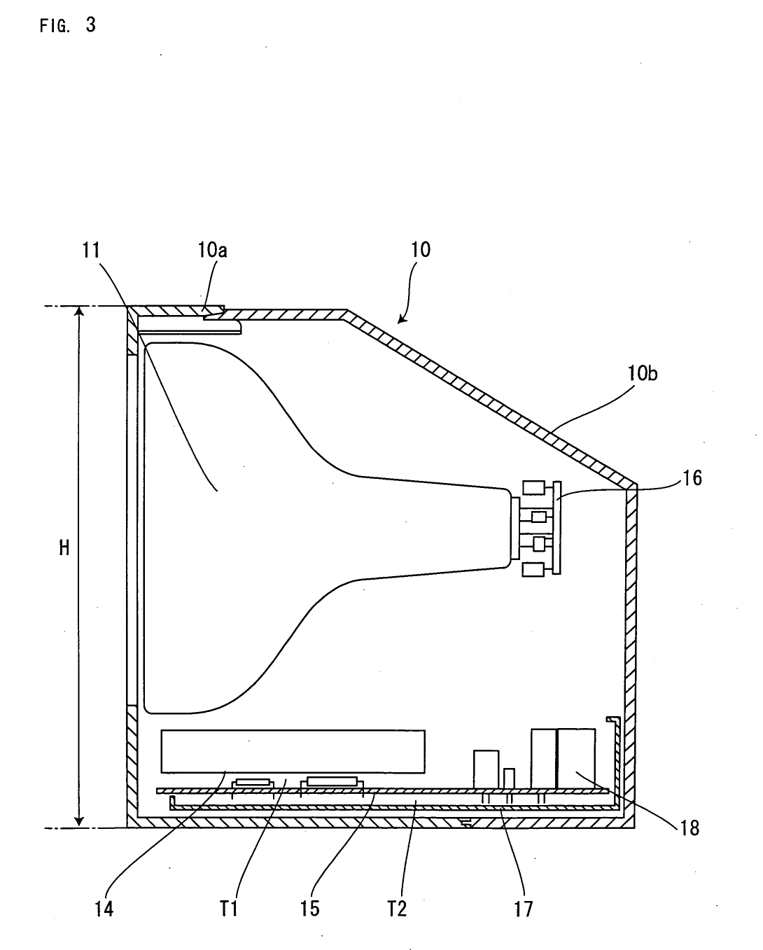

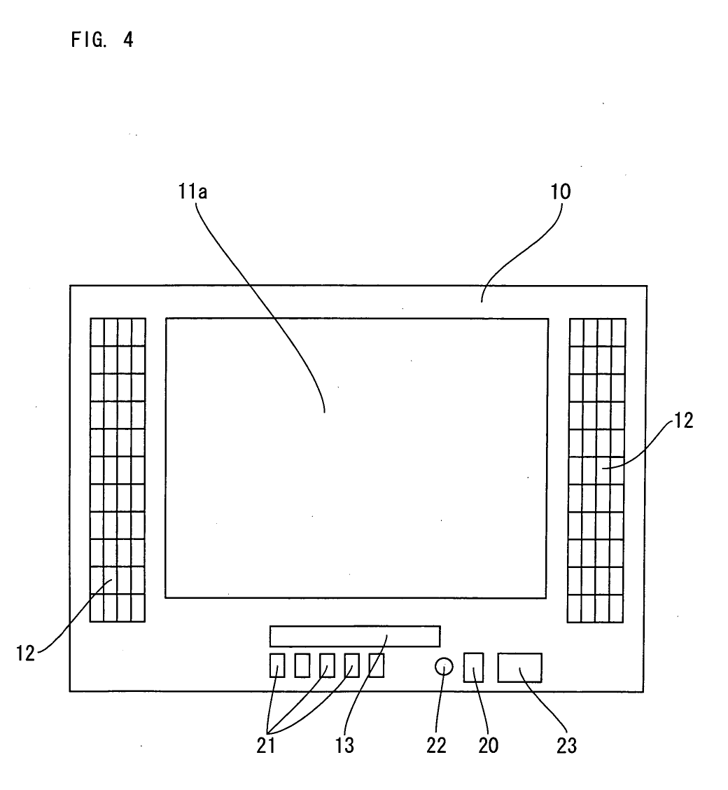

An preferred embodiment of the present invention is explained hereafter with reference to the drawings. Moreover, an arrangement of large functional units (24 inch type as example) and its dimensional example are illustrated in a television receiver with a Braun tube comprising a 21 inch-27 inch type built-in with the recording/playback device such as a DVD or the like in Embodiment 1. The reason the embodiment is illustrated by using specific numerical values is not intended to limit the present invention only to this scope of numerical values but to guarantee a space making possible to quantitatively estimate the specific effects. In the case of the embodiment, as shown in FIG. 3 and FIG. 4, a CRT display 11 is arranged at the case surface of a television receiver on the central upper side in its cross-wise direction, a carry-in/carry-out part 13 of a tray for replacing a recording medium of DVD similarly arranged in the center in the cross-wise direction, a DVD device 14 being mounted on the inner side of the case 10 of the television receiver. Moreover, two speakers 12 are mounted on both outer sides of the CRT display.

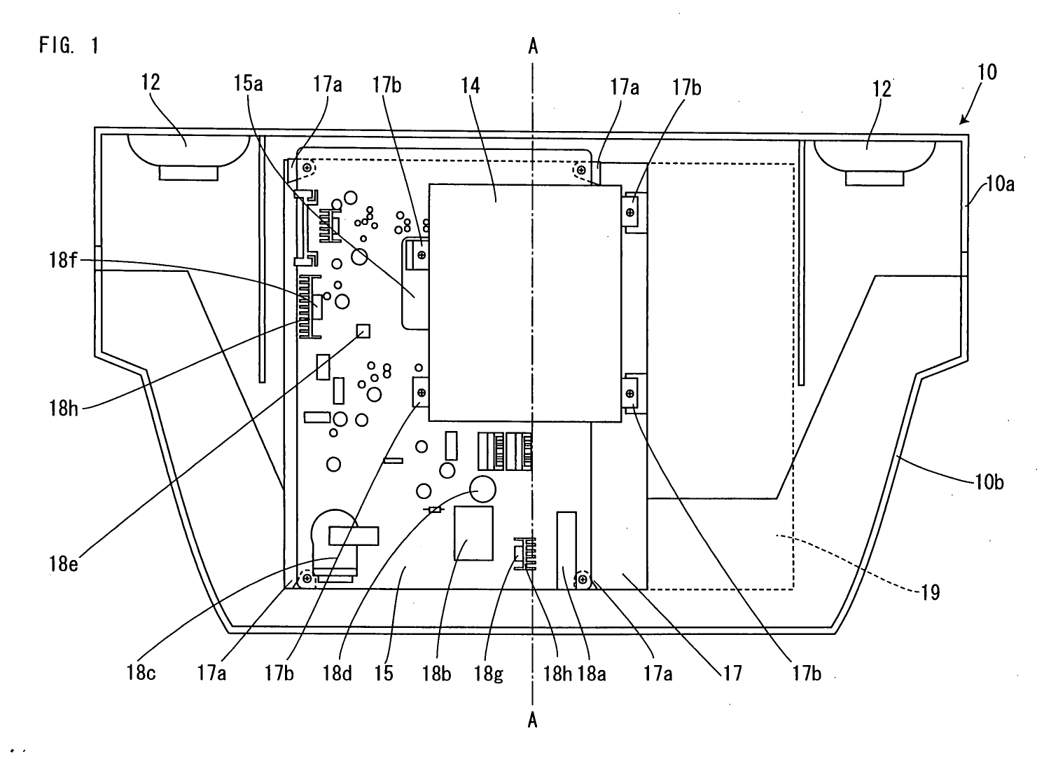

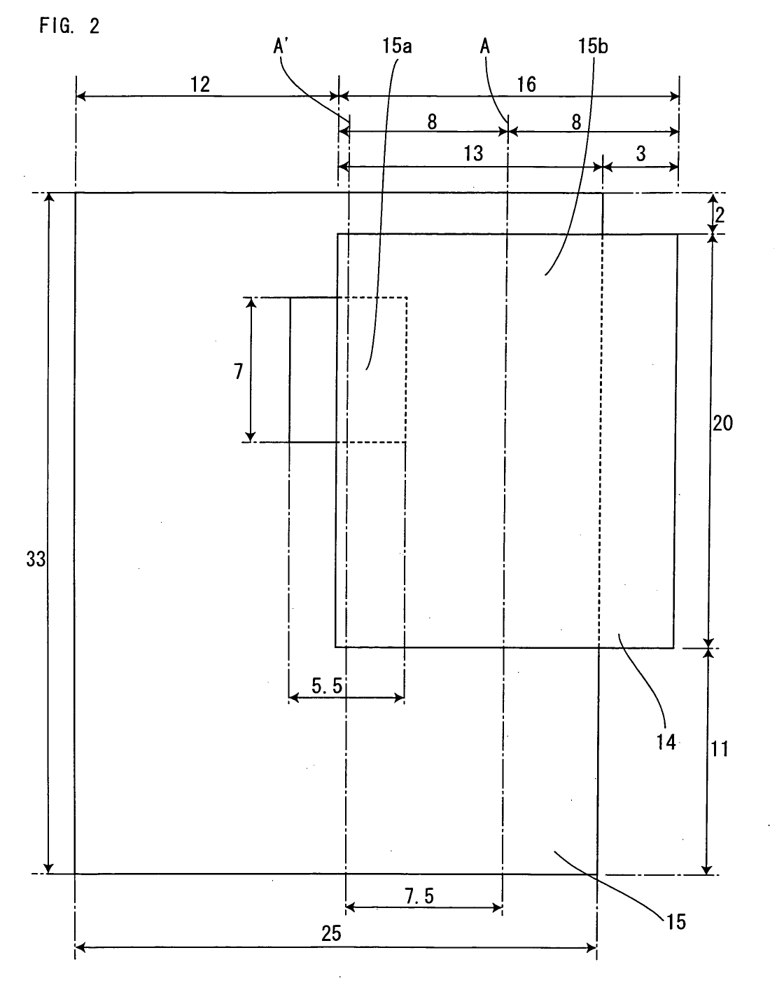

The size and arrangement of the functional units are described with reference to FIG. 1 and FIG. 2. The case 10 is constructed by a front case 10a and a rear case 10b, a chassis 17 which is made of a metal plate and guarantees its rigidity by bending its four sides has sizes of about 30 cm in width and about 31 cm in depth and is arranged on the floor in the case 10 by 5.5 cm offsetting it from the central line A to the right end of the electronic equipment combination of the present invention, and is allotted to 20.5 cm to the right and 9.5 cm to the left from the central line A. A main electronic circuit board 15 prepared as one-side board is placed on the chassis 17. As shown in FIG. 3, a main board support/fixing part 17a formed by cutting out a part of chassis 17 in several places is arranged as shown in FIG. 1 thereby obtaining a gap T2 of about 1 cm between the main board and the chassis to avoid an electric short-circuit between the metal chassis 17 and multiple terminals of electronic components passing through from the mounting surface of the electronic components forming the top of this main electronic circuit board 15 and protruding to the rear of board. As shown in FIG. 3, a DVD device support/fixing part 17b formed by cutting out a part of chassis 17 is arranged in several places in the positions shown in FIG. 1 so that a gap of about 1 cm is obtained as a gap T1 between the main board 15 and the lower end face of a DVD device 14. In this instance, the cutout height of the DVD device support/fixing part 17b is formed about 1 cm higher than the cutout height of the main board support/fixing part 17a.

The sizes of main electronic circuit board 15 placed on the chassis 17 are about 25 cm in width and about 33 cm in depth, a subsidiary board of about 5.5 cm in width and about 7 cm in depth for controlling a cathode ray tube is cut out to form a hole 15a. A DVD device 14 is placed in the central part of the receiver case 10 at the top of main electronic circuit board 15, and the DVD device 14 is about 16 cm in width, about 20 cm in depth and about 6 cm in thickness.

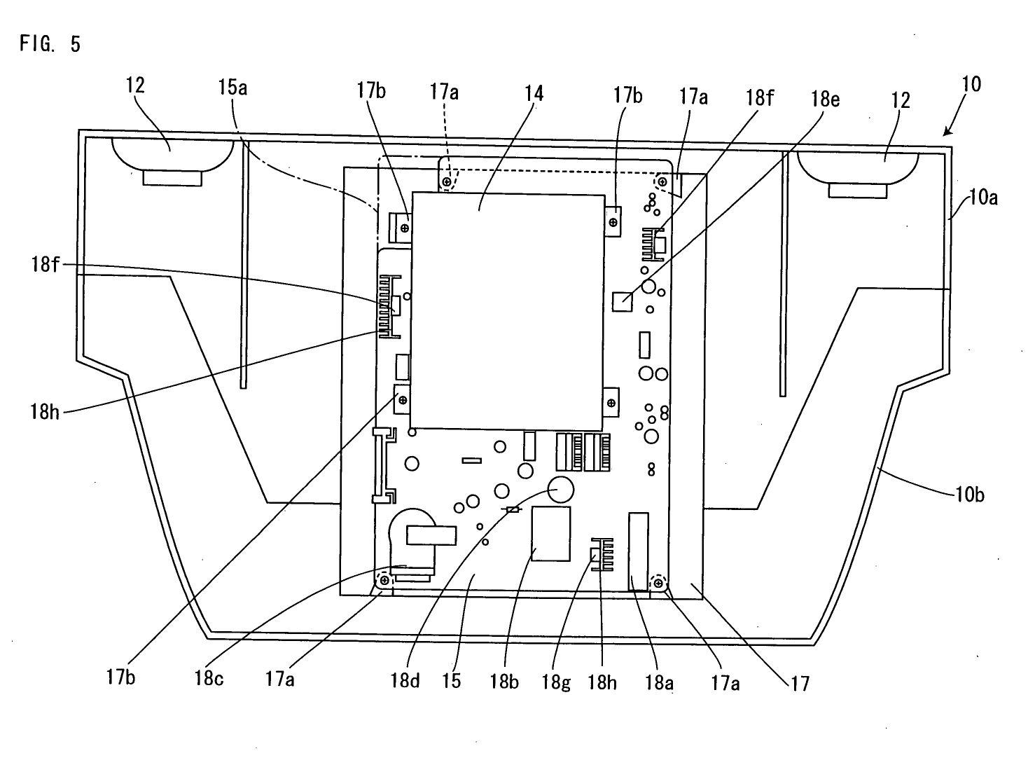

If the positional relation between the main electronic circuit board 15 and the chassis 17 is shown with the central line A of equipment as reference, the DVD device 14 of 16 cm in width is arranged so as to become left-right symmetric to this central line A, and is 8 cm on both the left and right to the central line A. On the other hand, the main board 15 of about 25 cm in width is offset by 7.5 cm (about ⅓ to width of main board and about ½ to width of DVD device) to become an allotment (about 4:1) of 20 cm to the right and 5 cm to the left to the central line A. Hence, the overlap of the main board and the chassis is 8 cm on the right and 5 cm on the left, and the total overlapping width is about 13 cm., guaranteeing an exposure area of about 20 cm-8 cm (12 cm) in width from the right end of DVD device to the right end of main board. The depth side end face of chassis and the end face of main board are placed in nearly agreement to the depth direction. 11 cm from this end face to this side is an exposure part of the main board, about 20 cm from which is an overlapping part with the DVD device, and the main board protrudes only about 2 cm to this side to mount jack terminals. If it is substituted by the area of main board, a cutout hole 15a of about 5.5 cm×7 cm (38.5 cm²) exists in the total surface area of about 25 cm×33 cm (825 cm²) and electronic components cannot be mounted, therefore, the major portion of the hole 15a is arranged so as to become an overlapping part with the DVD device. The overlapping part with the DVD device 14 of about 16 cm×20 cm (320 cm²) is about 13 cm×20 cm (260 cm²), but the major portion of the cutout hole 15a occupies in the part, therefore a wide L-shaped mountable surface area of electronic components, except for the overlapping part of DVD device 14 and the cutout hole 15a, is guaranteed from the right side of DVD device 14 to the deep side of the same device. Moreover, as shown in FIG. 5, a rectangular main board is placed to pre-enclose the DVD device 14, if the sizes of main board 15 of this embodiment are used as they are, in addition to an overlapping part 15b with the DVD device 14 of about 16 cm×20 cm (320 cm²), the hole 15a (38.5 cm²) generates as an unmountable surface area (320 cm²+38.5 cm²) of large electronic components. According to the offset arrangement of this embodiment, the overlapping part can be reduced to about 13 cm×20 cm (260 cm²), and a surface area of about 98.5 cm² can be utilized as mountable area of electronic components wider than before. In other words, if same electronic components are mounted as before, a main board narrower by at least a surface area of about 98.5 cm² (320 cm²+38.5 cm²-260 cm²) can be achieved by applying the present invention.

Since the total width in the case 10 of this embodiment somewhat exceeds 48 cm, a blank area 19 of about 13 cm in width and 31 cm in depth (expressed by a dotted line in FIG. 1) is guaranteed although it is an accompanying effect. Here, the present can also be put into the market as precedent kind of equipment which enables to attach an additional recording/playback device such as a 3.5 inch HDD or the like.

As described above, since the surface area of overlapping part 15b becoming the lower part of recording/playback device 14 such as a DVD or the like is decreased and a narrow long mounting area dispersed/arranged into a : shape on both sides of DVD device 14 can be put together into an L shape wider than before, the freedom degree of high-back electronic components 18, 18, mounting on the main electronic circuit board 15 is improved, enabling relaxing unreasonable wiring among electronic components and reduce the surface area of board by improving the mounting density of the main electronic circuit board 15 and enables to mount radiating fins 18h of a power transistor 18f and a thyristor 18g, a cement resistor 18e and the like which are mounted into a : shape so as to enclose the periphery of DVD device 14 and generate a higher temperature before in an L-shape wide area. Moreover, the installation of recording/playback device such as a DVD or the like attached later is facilitated by taking a structure capable of pre-assembling the built-in recording/playback device 14 such as a DVD or the like and electronic circuit board 15 on a metal chassis 17 and then handling them as a roughly integrated unit.

As described above, in this embodiment, a space on a main electronic circuit board can be effectively utilized by changing the main electronic circuit board into an offset arrangement to guarantee the mountable surface area of electronic components, and board sizes are decreased to contribute to the miniaturization of combination equipment, and the main electronic circuit board and a recording/playback device such as a DVD or the like can be pre-mounted on a chassis to become mountable as a set of units and then assembled to contribute to efficiency of operation.

This present embodiment was described in detail above, but is not limited to the embodiment and various modification embodiments are possible in the scope of substance of the present invention. For example, the size of CRT display of television receiver, the dimensions of chassis, main board and DVD device and the like or offset direction of main board as well as devices such as a DVD, HDD and the like as recording/playback devices are not limited to the embodiment and may be properly selected.

1. An electronic equipment combination provided with a recording/playback device characterized by the fact that, in an electronic equipment combination provided with a recording/playback device capable of inserting and discharging a recording medium and a television receiver provided with a Braun tube, the recording/playback device is arranged so that the carry-in/carry-out position of a tray for replacing the recording medium is centered in the cross-wise direction in front of the electronic equipment combination, in an offset arrangement of the recording/playback device and electronic circuit board relating to a power circuit or image signal processing and the like of the television receiver from the center of the electronic equipment combination the cross-wise direction.

2. An electronic equipment combination provided with a recording/playback device characterized by the fact that, in an electronic equipment combination provided with a recording/playback device capable of inserting and discharging a recording medium and a television receiver provided with a Braun tube, the recording/playback device is arranged so that the carry-in/carry-out position of a tray for replacing the recording medium is centered in the cross-wise direction in front of the electronic equipment combination, in an offset arrangement of the recording/playback device and electronic circuit board relating to a power circuit or image signal processing and the like of the television receiver from the center of the electronic equipment combination in the cross-wise direction and forming a space on the opposite side to the offset of the electronic circuit board.

3. The electronic equipment combination having the recording/playback device according to claim 1, characterized by the fact that the recording/playback device is a recording/playback device capable of inserting and discharging a recording medium such as a DVD or the like.

4. The electronic equipment combination having the recording/playback device according to claim 2, characterized by the fact that the recording/playback device is a recording/playback device capable of inserting and discharging recording medium such as a DVD or the like and the space formed on the opposite side to the offset of the electronic circuit board is a precedent space for arranging an HDD.

5. The electronic equipment combination having the recording/playback device according to claim 2, characterized by the fact that the recording/playback device is a recording/playback device capable of inserting and discharging a recording medium such as a DVD or the like.
